(19) United States
(12) Patent Application Publication
(10) Pub. No.: US 2012/0176412 A1
(43) Pub. Date: Jul. 12, 2012

(54) METHOD AND SYSTEM FOR IMPROVED MEDICAL IMAGE ANALYSIS

(75) Inventors: Susan Martignetti Stuebe, Whitefish Bay, WI (US); Amanda Fox, Fox Point, WI (US)

(73) Assignee: General Electric Company, Schenectady, NY (US)

(21) Appl. No.: 12/986,878

(22) Filed: Jan. 7, 2011

(51) Int. Cl. G09G 5/00

(52) U.S. Cl. 345/636

(57) ABSTRACT

The present disclosure is directed towards a method of efficient and unambiguous labeling of physiological features within medical image data during medical imagining analysis. For example, in one embodiment, the method includes receiving a selection of a label from a label tool, receiving one or more sets of coordinates that identify locations within an image associated with the selected label, defining a physiological feature within the image delineated by domains of shared physical properties within the medical image data and one or more identified locations associated with the selected label, and assigning the label to the defined feature.

### BACKGROUND OF THE INVENTION

The subject matter disclosed herein relates to medical image analysis, and more particularly, to efficient and unambiguous labeling of physiological features within medical image data.

There are numerous techniques employed by modern medical professionals for imaging biological tissue, each offering unique advantages and limitations based on the particular physics being employed. Common imaging techniques, including X-ray, CT, ultrasound, and MR imaging, can be used to generate image datasets having various two-dimensional and three-dimensional views of analyzed tissue. The resulting medical image datasets may be subsequently analyzed by a medical professional, wherein physiological features within the images may be defined and labeled. Due to the complexity of certain anatomical regions of the body, medical image analysis can be a cumbersome process. The process can be further hindered by potential ambiguity in the user interface, where it can become difficult to clearly understand what physiological feature is being labeled as well as which label belongs to a particular feature.

### BRIEF DESCRIPTION OF THE INVENTION

In one embodiment, a method of facilitating labeling during medical image analysis is provided. The method includes receiving a selection of a label, receiving one or more sets of coordinates that identify locations within an image associated with the selected label, defining a physiological feature within the image delineated by domains of shared physical properties within the medical image data and one or more identified locations associated with the selected label, and assigning the label to the defined feature.

In another embodiment, a system for medical image analysis is provided. The system includes input and output devices including a display and pointing device as well as one or more images that are representations of data from patient medical imaging. The system also includes a cursor that is configured to select a label and to select locations within an image associated with the selected label. The system also includes a processor executing commands to perform functions. These functions include receiving a selection of a label, receiving one or more locations on an image associated with the selected label, defining physiological features bound by one or more of the received locations and domains of common physical properties within the tissue, and assigning the label to the defined feature.

In another embodiment, one or more tangible, non-transitory, computer readable media encoded with one or more computer executable routines is provided. These routines, when executed by a processor, perform actions including receiving a selection of a label, receiving one or more locations on an image to be associated with the selected label, defining physiological features bound by one or more of the identified locations and domains of common physical properties within the image data, and assigning the label to the defined feature.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical view of a CT imaging system for use in producing images, in accordance with aspects of the present disclosure;

FIG. 2 is a flow diagram illustrating an embodiment of medical imaging analysis, in accordance with aspects of the present disclosure;

FIG. 3 illustrates receiving a label selection, in accordance with aspects of the present disclosure;

FIG. 4 illustrates receiving coordinates within an image to be associated with a selected label, in accordance with aspects of the present disclosure;

FIG. 5 illustrates defining a physiological feature, assigning a selected label to the feature, and displaying the label on an, in accordance with aspects of the present disclosure.

### DETAILED DESCRIPTION OF THE INVENTION

The approaches disclosed herein are suitable for analysis of medical image data obtained from a wide range of imaging techniques, such as, but not limited to, computed tomography (CT), C-arm angiography, standard radiography, magnetic resonance imaging (MRI), positron emission tomography (PET), ultrasound imaging, and so forth. To facilitate explanation, the present disclosure will primarily discuss the present image analysis approaches in the context of a CT system. However, it should be understood that the following discussion is equally applicable to other imaging techniques, such as those listed above as well as others.

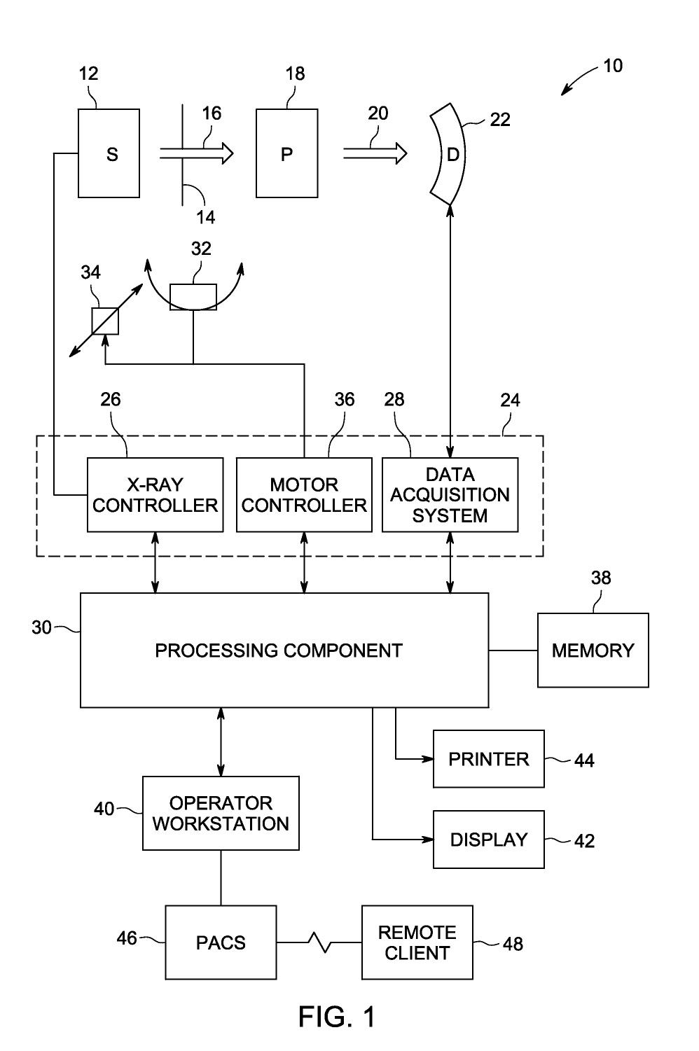

With this in mind, an example of a CT imaging system 10 designed to acquire X-ray attenuation data at a variety of views around a patient suitable for image analysis is provided in FIG. 1. In the embodiment illustrated in FIG. 1, imaging system 10 includes a source of X-ray radiation 12 positioned adjacent to a collimator 14. The X-ray source 12 may be an X-ray tube, a distributed X-ray source (such as a solid-state or thermionic X-ray source) or any other source of X-ray radiation suitable for the acquisition of medical or other images.

The collimator 14 permits X-rays 16 to pass into a region in which a patient 18, is positioned. A portion of the X-ray radiation 20 passes through or around the patient 18 and impacts a detector array, represented generally at reference numeral 22. Detector elements of the array produce electrical signals that represent the intensity of the incident X-rays 20. These signals are acquired and processed to reconstruct images of the features within the patient 18.

Source 12 is controlled by a system controller 24, which furnishes both power, and control signals for CT examination sequences. In the depicted embodiment, the system controller 24 controls the source 12 via an X-ray controller 26 which may be a component of the system controller 24. In such an embodiment, the X-ray controller 26 may be configured to provide power and timing signals to the X-ray source 12.

Moreover, the detector 22 is coupled to the system controller 24, which controls acquisition of the signals generated in the detector 22. In the depicted embodiment, the system controller 24 acquires the signals generated by the detector using a data acquisition system 28. The data acquisition system 28 receives data collected by readout electronics of the detector 22. The data acquisition system 28 may receive sampled analog signals from the detector 22 and convert the data to digital signals for subsequent processing by a processor 30 discussed below. Alternatively, in other embodiments the digital-to-analog conversion may be performed by circuitry provided on the detector 22 itself. The system controller 24 may also execute various signal processing and filtration functions with regard to the acquired image signals, such as for initial adjustment of dynamic ranges, interleaving of digital image data, and so forth.

In the embodiment illustrated in FIG. 1, system controller 24 is coupled to a rotational subsystem 32 and a linear positioning subsystem 34. The rotational subsystem 32 enables the X-ray source 12, collimator 14 and the detector 22 to be rotated one or multiple turns around the patient 18. It should be noted that the rotational subsystem 32 might include a gantry upon which the respective X-ray emission and detection components are disposed. Thus, in such an embodiment, the system controller 24 may be utilized to operate the gantry. The linear positioning subsystem 34 may enable the patient 18, or more specifically a table supporting the patient, to be displaced within the bore of the CT system 10. Thus, the table may be linearly moved within the gantry to generate images of particular areas of the patient 18. In the depicted embodiment, the system controller 24 controls the movement of the rotational subsystem 32 and/or the linear positioning subsystem 34 via a motor controller 36.

In general, system controller 24 commands operation of the imaging system 10 (such as via the operation of the source 12, detector 22, and positioning systems described above) to execute examination protocols and to process acquired data. For example, the system controller 24, via the systems and controllers noted above, may rotate a gantry supporting the source 12 and detector 22 about a subject of interest so that X-ray attenuation data may be obtained at a variety of views relative to the subject. In the present context, system controller 24 may also includes signal processing circuitry, associated memory circuitry for storing programs and routines executed by the computer (such as routines for executing image processing techniques described herein), as well as configuration parameters, image data, and so forth.

In the depicted embodiment, the image signals acquired and processed by the system controller 24 are provided to a processing component 30 for reconstruction of images. The processing component 30 may be one or more conventional microprocessors. The data collected by the data acquisition system 28 may be transmitted to the processing component 30 directly or after storage in a memory 38. Any type of memory suitable for storing data might be utilized by such an exemplary system 10. For example, the memory 38 may include one or more optical, magnetic, and/or solid state memory storage structures. Moreover, the memory 38 may be located at the acquisition system site and/or may include remote storage devices for storing data, processing parameters, and/or routines for iterative image reconstruction described below.

The processing component 30 may be configured to receive commands and scanning parameters from an operator via an operator workstation 40, typically equipped with a keyboard, a pointing device (e.g., mouse), and/or other input devices. An operator may control the system 10 via the operator workstation 40. Thus, the operator may observe the reconstructed images and/or otherwise operate the system 10 using the operator workstation 40. For example, a display 42 coupled to the operator workstation 40 may be utilized to observe the reconstructed images and to control imaging. Additionally, the images may also be printed by a printer 44 which may be coupled to the operator workstation 40.

Further, the processing component 30 and operator workstation 40 may be coupled to other output devices, which may include standard or special purpose computer monitors and associated processing circuitry. One or more operator workstations 40 may be further linked in the system for outputting system parameters, requesting examinations, viewing images, and so forth. In general, displays, printers, workstations, and similar devices supplied within the system may be local to the data acquisition components, or may be remote from these components, such as elsewhere within an institution or hospital, or in an entirely different location, linked to the image acquisition system via one or more configurable networks, such as the Internet, virtual private networks, and so forth.

It should be further noted that the operator workstation 40 may also be coupled to a picture archiving and communications system (PACS) 46. PACS 46 may in turn be coupled to a remote client 48, radiology department information system (RIS), hospital information system (HIS) or to an internal or external network, so that others at different locations may gain access to the raw or processed image data.

While the preceding discussion has treated the various exemplary components of the imaging system 10 separately, these various components may be provided within a common platform or in interconnected platforms. For example, the processing component 30, memory 38, and operator workstation 40 may be provided collectively as a general or special purpose computer or workstation configured to operate in accordance with the aspects of the present disclosure. In such embodiments, the general or special purpose computer may be provided as a separate component with respect to the data acquisition components of the system 10 or may be provided in a common platform with such components. Likewise, the system controller 24 may be provided as part of such a computer or workstation or as part of a separate system dedicated to image acquisition.

After medical imaging of a patient is completed, and the resulting image dataset has been processed to produce an image, or a series of images, representing the characterized tissue, image analysis may ensue. During computer-based medical image analysis, these images may be presented to a medical professional, along with a set of tools and labels, for analyzing and annotating various features contained within the image data. In some embodiments, medical image analysis may be performed on the operator workstation 40, using its input devices and display 42 to allow the medical professional to interact with the image data. In other embodiments, medical image analysis may take place on a system that is separate from the operator workstation 40, such as a remote client 48 accessing the image data via the PACS 46.

Medical image data typically contains information regarding the physical properties of the imaged tissue, and within this data are generally domains of common or shared physical properties based on what is actually being measured within the tissue. These shared physical properties may define common, contiguous, or continuous structures or surfaces and may include density, acoustic impedance, echogenicity, relative motion or flow, relative velocity, spin density, magnetic resonance T₁ or T₂ relaxation times, radiation absorptance or attenuance, radiation transmittance, contrast agent concentration, and the like. In one embodiment, regions of shared physical properties (e.g., structures, surfaces, vessels, and so forth) may be defined (i.e. labeled) within the image data based on these shared or common properties. In such an embodiment, when a label is applied to a region, other pixels or voxels identified as corresponding to the region or having the common properties (such as a defined surface or threshold) may also be correspondingly labeled. In one embodiment, the boundaries of the region are highlighted using the same color displayed on the modified cursor for further clarity.

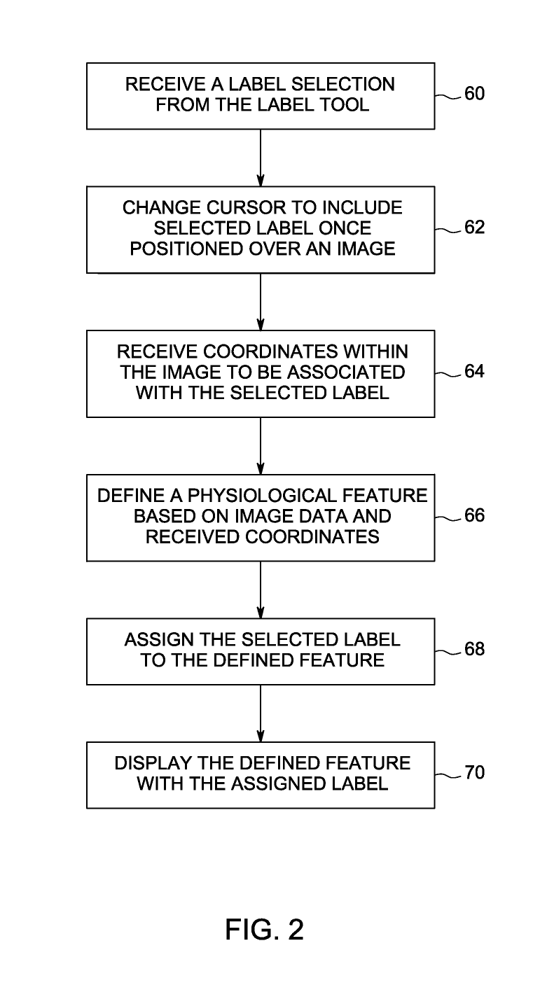

Generally referring to FIG. 2, a flow diagram is presented illustrating an embodiment of the present method of feature labeling during medical image analysis. In the illustrated embodiment, the method depicted first receives (block 60) a selection of a particular label from the label tool displayed with the image being analyzed. As will be appreciated, the medical image analysis discussed herein may be performed by an operator at one or more of the components of the system 10 noted above, such as at workstation 40 or remote client 48. In one embodiment, the selection of a label occurs within a label tool box or palette that contains a list labels for physiological features that are potentially contained within the image. In one such embodiment, the label selection occurs through the use of a cursor controlled by a mouse or similar input device, and upon selection, the appearance of the label within the label tool box or palette may be highlighted to indicate its selected status.

In the illustrated embodiment, once the label has been selected, the appearance of the cursor may be altered (block 62) when the cursor is positioned over an image. In one such embodiment, the appearance of the cursor is modified to include the text of the selected label, or any identifying portion thereof. Such an embodiment allows the user to visualize, without ambiguity, which label is being associated with the image at a particular time. In such an embodiment, the cursor may also revert to the appearance it displayed prior to label selection whenever the cursor is not positioned over an image or whenever a label is no longer selected in the label tool.

In one embodiment, after a label has been selected, a location within an image may be selected using the modified cursor, resulting in the selected coordinates (block 64) being associated with the selected label within the image. In such an embodiment, these coordinates represent pixels or voxels within the image data that are associated with a physiological feature identified by the selected label. In one embodiment, only one set of coordinates is received, and these coordinates represent pixels or voxels within a physiological feature contained within the image. In another embodiment, multiple coordinates are received for a particular label, defining starting, ending, center, or edge points for a particular physiological feature displayed in the image. In some embodiments, one or more markers may be displayed on the image to highlight locations on the image that have been associated with a particular label.

In the depicted embodiment, the received coordinates associated with a particular selected label, along with boundaries gleaned from domains of common or shared physical properties within the image data (as discussed above), may be used to define (block 66) a physiological feature or property within the image data. In such an embodiment, the defined boundaries of a feature may be highlighted for clarity when displayed within an image. In one embodiment, the defined boundaries of the region may be highlighted using the same color displayed on the modified cursor for further clarity. In one embodiment directed toward image analysis of vascular systems in CT angiography, a starting and ending locations for a particular vessel may be received by the method for association with a particular label. In such an embodiment, the method may employ a centerline (or similar) algorithm to define the boundaries of the vessel based upon contrast agent concentration within the image data between the starting and ending locations received for the label. In another embodiment specifically directed toward image analysis of ultrasound data, a single location within the image may be received by the method for association with a particular label. In such an embodiment, the method may employ a feature-defining algorithm to define the boundaries of a particular piece feature, based upon isoechogenic regions within the image data, which enclose the location received for the label.

In the depicted embodiment, the selected label may be assigned (block 68) to the defined feature, and the defined feature with the assigned label may be displayed (block 70). In one embodiment, the currently displayed image may only represent a subset of the image data (e.g., a two-dimensional view representative of a single slice of three-dimensional image data). In such an embodiment, the label may be assigned to a particular physiological feature throughout the entirety of the image volume or data after label assignment has been performed for particular view or subset of the image data. Accordingly, in such an embodiment, the assigned label may be displayed for all views or slices (e.g., images) generated based on the image data or volume that contain a portion of the defined feature. In displaying the label, some embodiments may denote the assignment of a label to a feature by employing a common highlighting color for both the boundaries of the defined feature and the assigned label. Other embodiments may indicate the assignment of a particular label to its assigned feature by displaying the assigned label on the image so that it is tangent to the assigned feature. Some embodiments may also possess an algorithm that determines the best (e.g., least cluttered) area of an image to display labels near their assigned features.

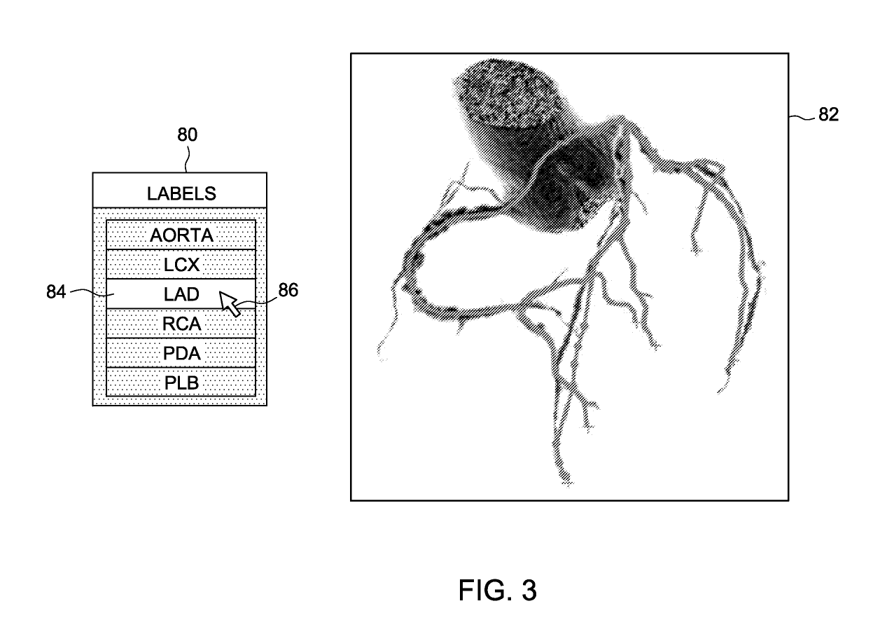

FIGS. 3-5 illustrate simulated screen-shots for specific embodiments of the present method directed towards labeling blood vessels during CT image analysis. FIG. 3 illustrates label selection, in which a label tool 80 contains a series of labels that represent different anatomical features potentially represented in a medical image 82. A particular label 84 may be selected using a cursor 86, and upon receiving the selection, the selected label 84 in the label tool 80 may be highlighted to denote its selected status. As one skilled in the art would appreciate, image 82 need not be the only image displayed for analysis at one time, nor the label tool 80 the only tool box or palette available for image analysis and annotation.

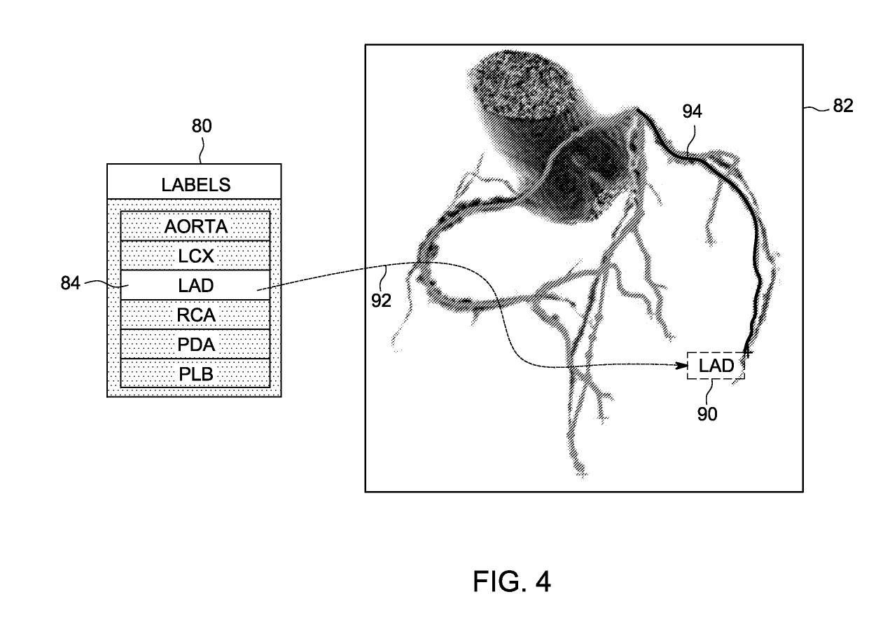

FIG. 4 illustrates an embodiment in which a label 84 has been selected from the label tool 80, and the cursor 90 was subsequently moved over the image 82 along a path 92. Accordingly, the appearance of the cursor 90 in the depicted embodiment has been modified to display text identifying the selected label 84. FIG. 4 further illustrates the movement of the cursor 90 along the path 92 to rest over a particular feature 94 within the image 82. In one embodiment, when the cursor 90 is positioned over the feature 94 either or both of the cursor or feature may be highlighted for clarity. In such an embodiment, when a location is specified on the feature 94 using the cursor 90, the method receives the coordinates within the image 82 associated with the label 84.

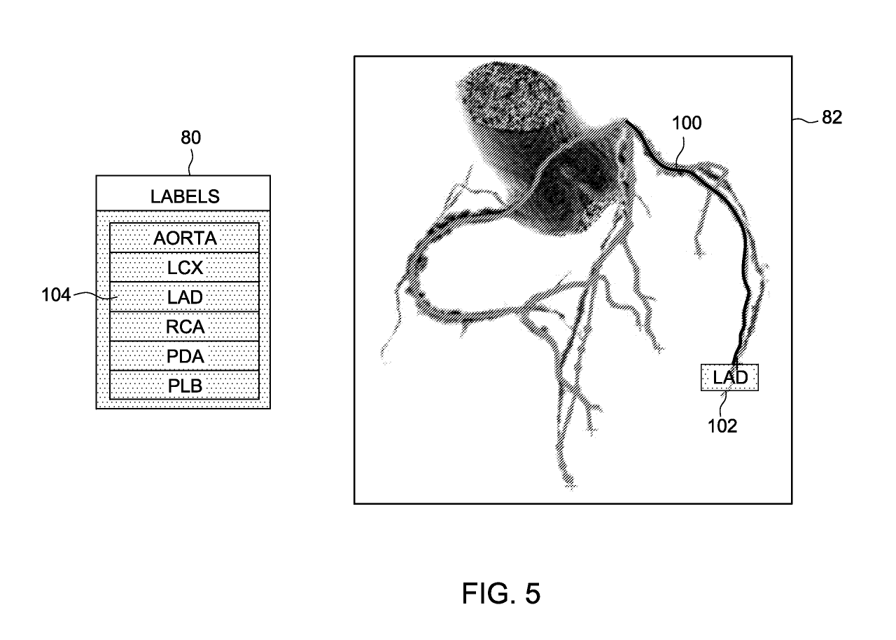

FIG. 5 illustrates an embodiment in which a physiological feature 100 has been defined and assigned a label 102. In one embodiment, either or both the boundaries of the feature 100 or the assigned label 102 are highlighted in a common color when displayed on the image 82. In such an embodiment, after assignment is completed, the highlighting of the previously selected label 104 in the label tool 80 is removed to denote that no label is currently selected.

Technical effects of the invention include the ability to efficiently and unambiguously define and label physiological features within medical image data during medical image analysis. Further, the present disclosure allows for improved workflow by improving the speed at which features may be annotated during medical image analysis while minimizing potential user mistakes.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method of facilitating labeling during medical image analysis comprising:
receiving a selection of a label;
altering the appearance of a cursor based upon the selected label;
receiving one or more sets of coordinates identifying locations within an image associated with the selected label;
defining a physiological feature within the image delineated by domains of shared physical properties within the medical image data and one or more identified locations associated with the selected label; and
assigning the label to the defined feature.

2. A method of claim 1, wherein the label is selected from a label tool, and the appearance of the label in the label tool is altered to reflect its selected status.

3. A method of claim 2, wherein after the selected label has been assigned to the defined feature, the label is automatically deselected in the label tool, and the appearance of the label in the label tool is altered to reflect its deselected status.

4. A method of claim 1, wherein the appearance of the cursor is altered to include text identifying the selected label when the cursor is positioned over an image.

5. A method of claim 1, wherein shared physical properties within the medical image data comprise one or more of density, acoustic impedance, echogenicity, relative motion or flow, relative velocity, spin density, magnetic resonance T₁ or T₂ relaxation times, radiation absorptance or attenuance, radiation transmittance, or contrast agent concentration.

6. A method of claim 1, wherein the defined feature and its assigned label are displayed in the image after assignment.

7. A method of claim 1, wherein if the defined feature is present in within related images, the defined feature and its assigned label are automatically displayed on those images.

8. A medical image analysis system comprising:
input and output devices comprising a display and pointing device;
one or more images from an image dataset that are representations of patient tissue from medical imaging;
a cursor operable to select a label and to select locations within an image to be associated with a selected label;
a processor executing commands to perform functions, comprising:
receiving a selection of a label;
altering the appearance of a cursor based upon the selected label;
receiving one or more locations on an image associated with the selected label;
defining physiological features bound by one or more of the received locations and domains of common physical properties within the imaged tissue;
assigning the label to the defined feature.

9. A system of claim 8, wherein the system comprises a label tool including labels for physiological features that is configured to receive a label selection from the cursor and alter the appearance of the label in the label tool to reflect the selected status of the label.

10. A system of claim 9, wherein after the selected label has been assigned to the defined feature, the label is automatically deselected in the label tool, and the appearance of the label in the label tool is altered to reflect its deselected status.

11. A system of claim 8, wherein the appearance of the cursor is altered to include text identifying the selected label when the cursor is positioned over an image.

12. A system of claim 8, wherein shared physical properties within the medical image data comprise one or more of density, acoustic impedance, echogenicity, relative motion or flow, relative velocity, spin density, T₁ or T₂ relaxation times, radiation absorptance or scattering, radiation transmittance, or contrast agent concentration.

13. A system of claim 8, wherein the defined feature and its assigned label are displayed on the image.

14. A system of claim 8, wherein if the defined feature is present within other images in the image dataset, the defined feauture and its assigned label are automatically displayed on these images.

15. One or more tangible, non-transitory, computer-readable media encoded with one or more routines, wherein the routines when executed by a processor perform actions comprising:
receiving a selection of a label;
altering the appearance of a cursor based upon the selected label;
receiving one or more locations on an image associated with the selected label;
defining physiological features bound by one or more of the identified locations and domains of common physical properties within the medical image data; and
assigning the label to the defined feature.

16. The one or more tangible, non-transitory, computer-readable media of claim 15; wherein the label is selected from a label tool, and the appearance of the label in the label tool is altered to reflect its selected status.

17. The one or more tangible, non-transitory, computer-readable media of claim 16; wherein after the selected label has been assigned to the defined feature, the label is automatically deselected in the label tool, and the appearance of the label in the label tool is altered to reflect its deselected status.

18. The one or more tangible, non-transitory, computer-readable media of claim 15; wherein the appearance of the cursor is altered to include text identifying the selected label when the cursor is positioned over an image.

19. The one or more tangible, non-transitory, computer-readable media of claim 15; wherein shared physical properties within the medical image data comprise one or more of density, acoustic impedance, echogenicity, relative motion or flow, relative velocity, spin density, magnetic resonance T₁ or T₂ relaxation times, radiation absorptance or attenuance, radiation transmittance, or contrast agent concentration.

20. The one or more tangible, non-transitory, computer-readable media of claim 15; wherein the defined feature and the assigned label are displayed on the image.
